(19) United States
(12) Patent Application Publication
(10) Pub. No.: US 2026/0287172 A1
(43) Pub. Date: Sep. 24, 2026

(54) Valve Assembly for a Gas Burner

(71) Applicant: COPRECI, S.COOP., Aretxabaleta (ES)

(72) Inventors: Javier MARTIN SANCHEZ, Arrasate-Mondragon (ES); Lander ABARRATEGI AZKARATE, Urretxu (ES)

(21) Appl. No.: 19/545,457

(22) Filed: Feb. 20, 2026

(30) Foreign Application Priority Data
Mar. 19, 2025 (EP) 25382260.5

(51) Int. Cl. F23K 5/00; F16K 1/52

(52) U.S. Cl. CPC F23K 5/007; F16K 1/52

(57) ABSTRACT

A valve assembly including a regulation valve arranged between gas inlet and outlet conduits. The regulation valve includes a stem that is movable between a first axial position and a second axial position. The stem including a main plug and an auxiliary plug. In the first axial position the main plug cooperates with a main valve seat to block a main valve opening, in the second axial position of the stem the main plug does not cooperate with the main seat to permit gas to pass from the gas inlet conduit to the gas outlet conduit. In the first axial position the auxiliary plug does not cooperate with an auxiliary valve seat, in the second axial position of the stem the auxiliary plug cooperates with the auxiliary valve seat. The regulation valve further includes a bypass conduit through which gas passes when the stem is in the second axial position.

### CROSS-REFERENCE TO RELATED APPLICATIONS

This application relates to and claims the benefit and priority to European Patent Application No. 25382260.5, filed Mar. 19, 2025, which is incorporated herein by reference in its entirety.

### TECHNICAL FIELD

The present invention relates to valve assemblies for gas burners comprising a regulation valve for regulating the gas flow.

### BACKGROUND

Gas burners usually incorporate a regulation valve to regulate the gas flow between a minimum and a maximum gas flow. This type of valve is usually proportional since, depending on how much it is opened, it will allow to pass more or less gas to the outlet.

In a closed position of the regulation valve the gas cannot flow to the outlet and in an open position of the valve the gas will be able to flow to the outlet.

There are rotary regulation valves and axial regulation valves. In the first type of valves, depending on the angle of rotation of the valve, they will allow to pass more or less gas, and in the second type of valves, depending on the axial displacement of the valve, they will allow to pass more or less gas. The second type of valves includes pressure regulating valves which incorporate a diaphragm to regulate the outlet gas pressure.

In this regard, US20220075398 A1 discloses a valve assembly comprising a pressure regulation valve of the type comprising a diaphragm. The valve assembly comprises a main body, a gas inlet conduit, a gas outlet conduit, a pressurized gas chamber, an air chamber and a diaphragm associated with a stem of the regulation valve. The air chamber and the gas chamber are delimited by the diaphragm, which due to the pressure difference between both chambers can be displaced, in turn axially displacing the stem of the regulation valve.

The regulation valve comprises a main valve seat which delimits a main valve opening, and the stem comprises a main plug which cooperates with the main valve seat, so that when the regulation valve is in a closed position where no gas is allowed to pass from the inlet conduit to the outlet conduit, the main plug rests on the main valve seat, blocking the main valve opening, the gas flow being able to be regulated by separating the main plug from the main valve seat. In this case, in a rest and stable position of the regulation valve, i.e. when no gas is flowing through the inlet conduit, the regulation valve is open and when the gas pressure in the inlet conduit increases, the regulation valve tends to close.

### SUMMARY

Disclosed is a valve assembly comprising a main body, a gas inlet conduit, a gas outlet conduit, and a regulation valve arranged between the inlet conduit and the outlet conduit.

The regulation valve comprises a main valve seat which delimits a main valve opening, and an axially movable stem comprising a main plug which cooperates with the main valve seat, so that when the regulation valve is in a closed position where no gas is allowed to pass from the inlet conduit to the outlet conduit, the main plug rests on the main valve seat blocking the main valve opening, the gas flow being able to be regulated by separating said main plug from the main valve seat.

The regulation valve of the invention also comprises an auxiliary valve seat which delimits an auxiliary valve opening. The stem also comprises an auxiliary plug which cooperates with the auxiliary valve seat so that, with the regulation valve being in a minimum flow position, the auxiliary plug rests on the auxiliary valve seat blocking the auxiliary valve opening, allowing said minimum flow to pass to the outlet conduit through at least one bypass opening arranged downstream of the main valve opening.

With the valve assembly of the invention, it is possible to stabilize the gas flow rate for a minimum gas flow rate of the valve assembly in a simple and economical way, without the need for additional elements such as diaphragms.

These and other advantages and features of the invention will become apparent in view of the figures and the detailed description.

### BRIEF DESCRIPTION OF THE DRAWINGS

FIG. 1 shows a perspective view of the valve assembly of the according to an embodiment.

FIG. 1A shows a sectional view of the valve assembly shown in FIG. 1, with the regulation valve of the valve assembly being closed.

FIG. 1B shows another sectional view of the valve assembly shown in FIG. 1, but with the regulation valve of the valve assembly being in the minimum flow rate position.

FIG. 1C shows a detail of the valve assembly of FIG. 1B.

FIG. 2A shows a sectional view of the valve assembly according to another embodiment, where the regulation valve of the valve assembly is closed.

FIG. 2B is a detail of the valve assembly of FIG. 2A.

FIG. 2C is a sectional view of the valve assembly shown in FIG. 2A, but where the regulation valve is in the minimum flow rate position.

FIG. 2D shows another sectional view where from the sectional view of FIG. 2C, partial section A has been added to show a detail of the corresponding bypass opening.

FIG. 2E shows a detail of the partial section A shown in FIG. 2D.

FIG. 3A shows a sectional view of the valve assembly according to another embodiment, where the regulation valve of the valve assembly is closed.

FIG. 3B shows another sectional view of the valve assembly shown in FIG. 3A, but where the regulation valve is in the minimum flow rate position.

### DETAILED DESCRIPTION

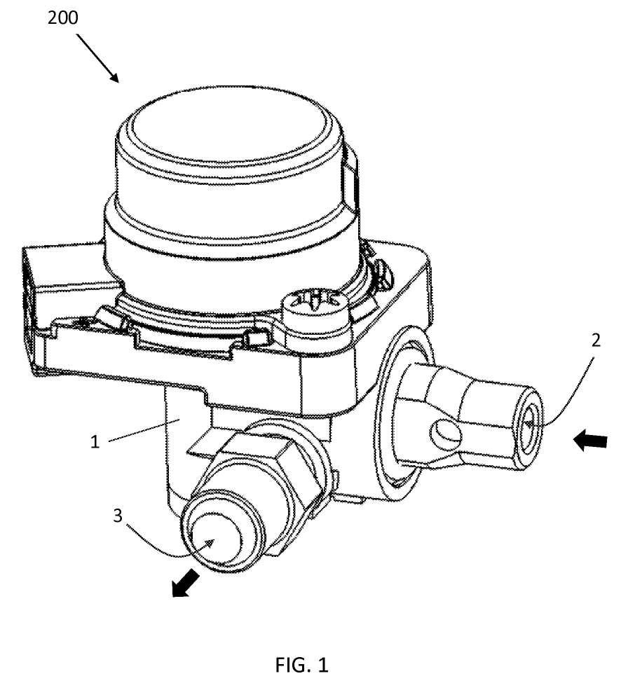

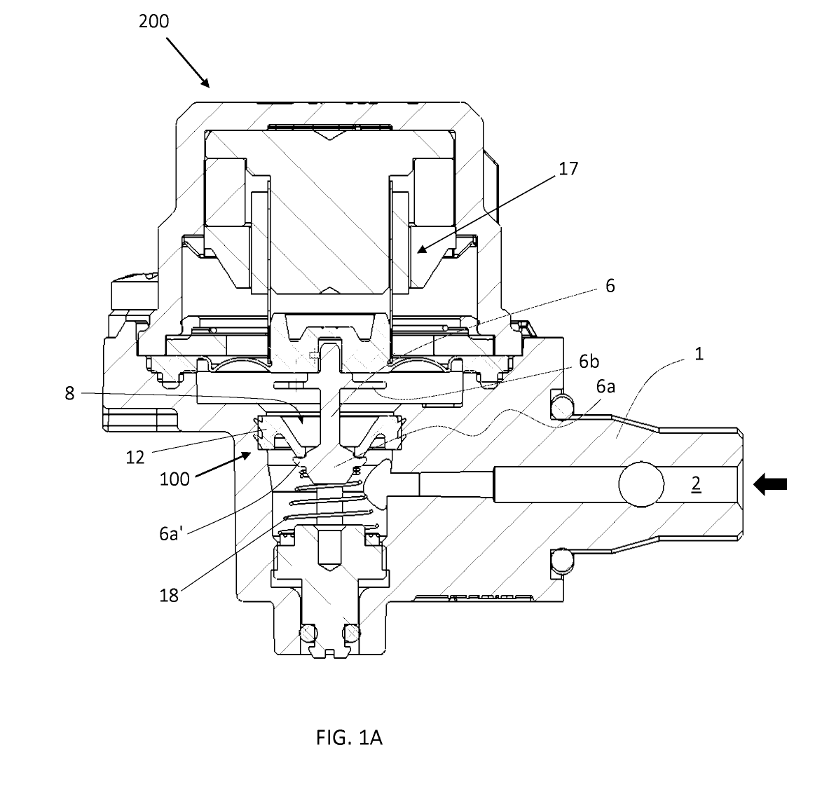

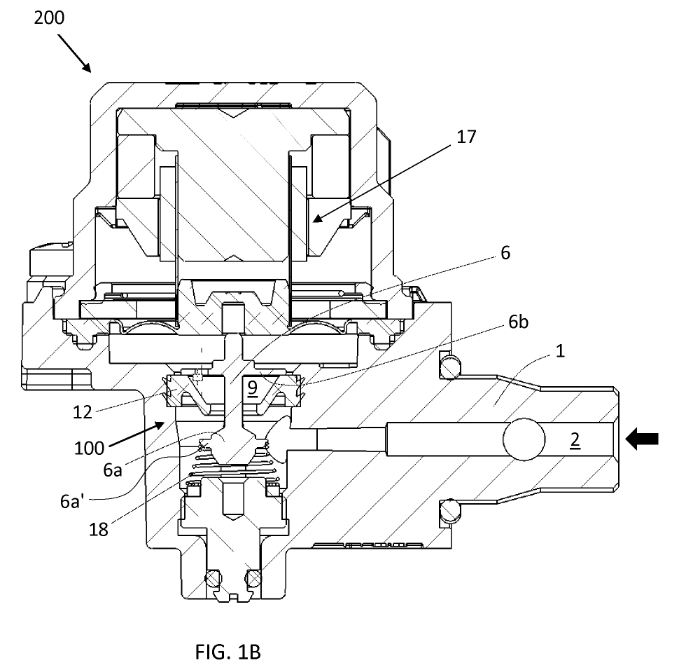

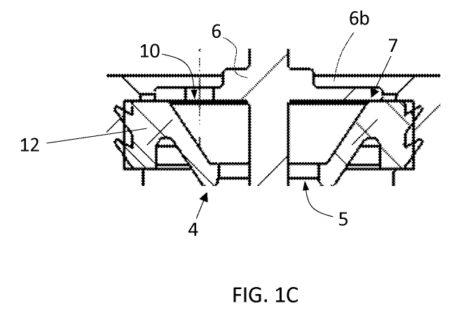

FIGS. 1, 1A, 1B and 1C show a valve assembly 200 according to an embodiment of the invention. As shown in said figures, the valve assembly 200 of the invention comprises a main body 1, a gas inlet conduit 2, a gas outlet conduit 3, and a regulation valve 100 arranged between the inlet conduit 2 and the outlet conduit 3.

The regulation valve 100 comprises a main valve seat 4 delimiting a main valve opening 5, and an axially movable stem 6 comprising a main plug 6a cooperating with the main valve seat 4, so that when the control valve 100 is in a closed position where no gas is allowed to pass from the inlet conduit 2 to the outlet conduit 3, the main plug 6a rests on the main valve seat 4 blocking the main valve opening 5, the gas flow being able to be regulated by separating said main plug 6a from the main valve seat 4.

The regulation valve 100 of the invention also comprises an auxiliary valve seat 7 delimiting an auxiliary valve opening 8. The stem 6 also comprises an auxiliary plug 6b which cooperates with the auxiliary valve seat 7, so that when the control valve 100 is in a minimum flow position where a minimum flow rate, called Q_{MIN}, is allowed to pass, the auxiliary plug 6b rests on the auxiliary valve seat 7 blocking the auxiliary valve opening 8, allowing the passage of said minimum flow Q_{MIN} to the outlet conduit 3 through at least one bypass opening 10 or 10' which is arranged downstream of the main valve opening 5.

Said bypass opening 10 or 10' is sized to allow the passage of the preset minimum flow rate Q_{MIN}, said minimum flow rate Q_{MIN} being the minimum flow rate that the valve assembly 200 can supply.

At low flow rates the gas pressure in the outlet conduit 3 of the valve assembly 200 can easily fluctuate, and therefore, in the absence of a diaphragm, the bypass opening 10 or 10' of the invention allows the gas flow rate to be stabilized at said minimum flow rate position in a simple and economical manner. Thus, when the user selects the Q_{MIN} position in an appliance comprising a gas burner comprising the valve assembly 200 of the invention, the supply of said minimum flow rate Q_{MIN} is ensured, without fluctuations. Moreover, as the supply of the minimum flow rate is more stable, the nominal value of the minimum flow rate can even be adjusted by reducing it.

In the valves of the prior art, in the Q_{MIN} position, it is very difficult to keep the stem displaced just enough to open the valve the minimum to provide the minimum flow rate Q_{MIN} without it fluctuating, since the stem displacement must be very small. Therefore, with the valve assembly 200 of the invention to ensure the supply of said minimum flow rate it is possible to increase the displacement of the stem 6, since the gas passage in the position of Q_{MIN} will no longer depend on the gap delimited by the main valve opening 5 and the main plug 6a of the stem 6, but by the bypass opening 10 or 10', whose passage section remains constant during the use of the valve assembly 200, although as will be seen further bellow, it is possible to predefine a bypass opening for each type of gas, for example for natural gas (NG) or liquefied petroleum gas (LPG).

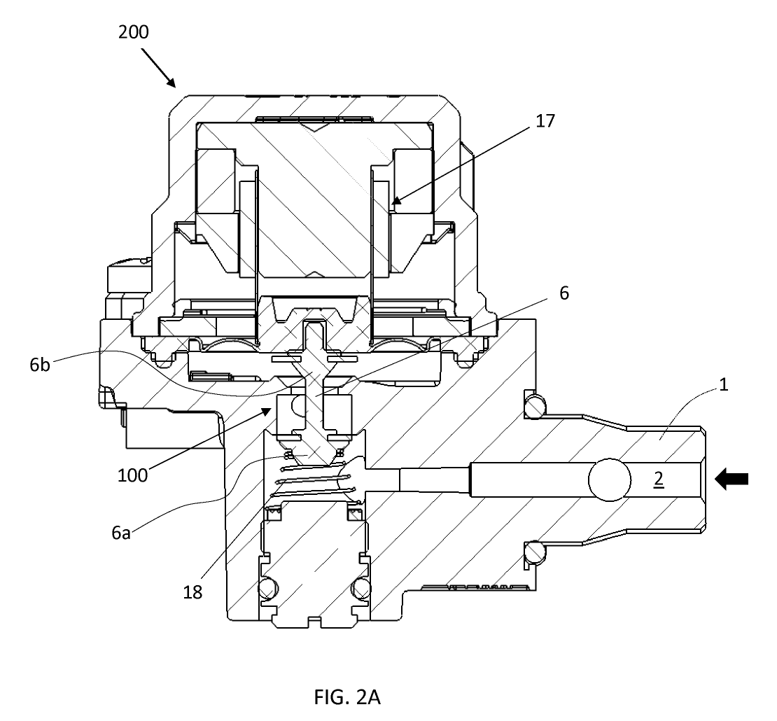

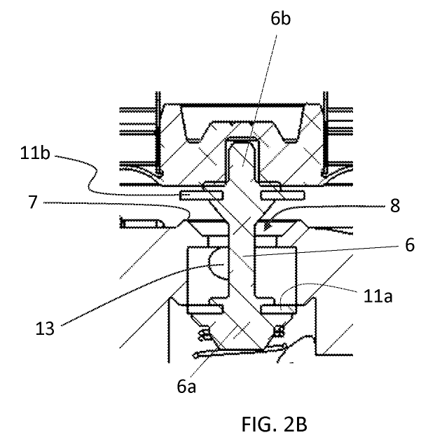

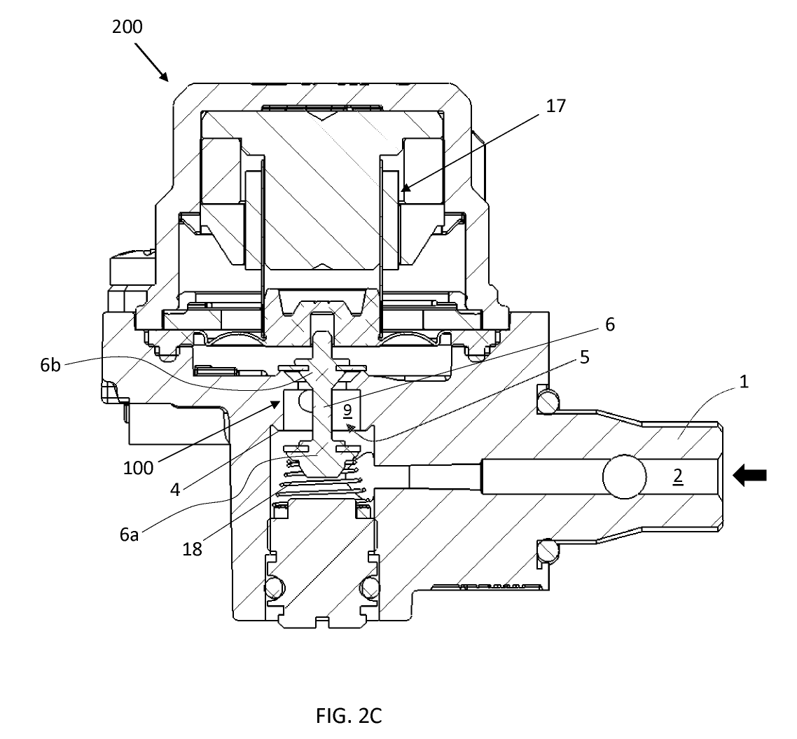

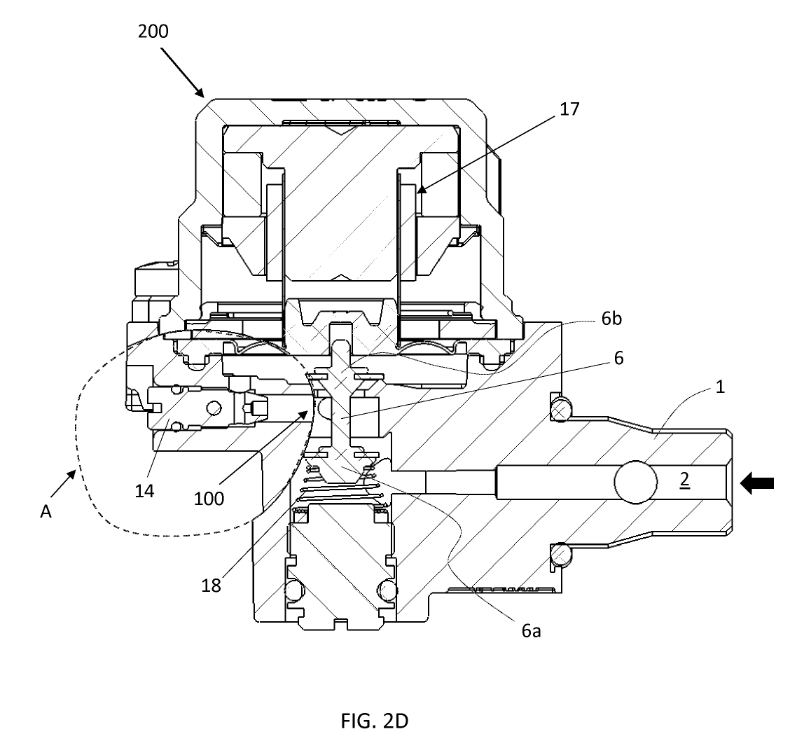

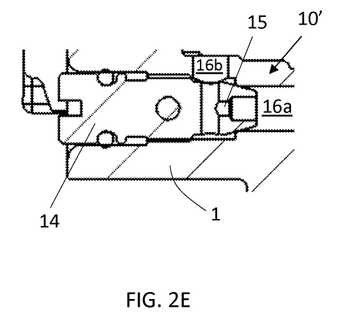

In this sense, starting from a neutral position of the stem 6, shown in FIGS. 1A and 2A, where the regulation valve 100 is closed, i.e. the main plug 6a blocks the main valve opening 5, the displacement of the stem 6 at the position of Q_{MIN} is the maximum, said displacement being delimited until the auxiliary plug 6b of the stem 6 rests on the auxiliary valve seat 7, i.e. until the auxiliary plug 6b blocks the auxiliary valve opening 8. In this position of the stem 6, i.e. where the displacement of the stem 6 is the maximum, the gap between the main valve opening 5 and the main plug 6a is also the maximum, but the flow rate supplied by the control valve 100 to the outlet conduit 3 is the minimum.

For other positions of the regulation valve 100 of the invention, for example to supply a maximum gas flow rate, referred to as Q_{MAX}, the stem 6 will reduce its displacement, i.e. it will move so that the auxiliary plug 6b moves away from the auxiliary valve seat 7, and the main plug 6a moves closer to the main valve seat 4, allowing gas to flow into the outlet conduit 3 through the gap delimited by the auxiliary valve opening 8 and the auxiliary plug 6b of the stem 6. The larger the gap delimited by the auxiliary valve opening 8 and the auxiliary plug 6b, the greater the flow rate of gas supplied to the outlet conduit 3, and vice versa.

When the stem 6 returns to the neutral position, the regulation valve 100 closes, preventing gas to flow to the outlet conduit 3 because the main plug 6a blocks the main valve opening 5.

In the preferred embodiment of the invention, the stem 6 is associated with actuating means of the valve assembly 100 which allow the stem 6 to be axially displaced. In a non-limiting example of the invention, the actuation means comprise an electromagnetic actuator 17 and elastic means, preferably a spring 18, as shown in the figures. In the closed position of the regulation valve 100 the electromagnetic actuator 17 is not activated and the elastic means tends to go to a rest position pushing the main plug 6a of the stem 6 against the main valve seat 4, see for example FIGS. 1A and 2A, bringing the stem 6 to its neutral position. When the electromagnetic actuator 17 is actuated, the stem 6 is displaced moving the main plug 6a away from the main valve seat 4, compressing the elastic means 18 and opening the regulation valve 100.

In the preferred embodiment of the invention, when the regulation valve 100 is in the minimum flow position Q_{MIN} an intermediate chamber 9 is generated between the stem 6, the main valve seat 4 and the auxiliary valve seat 7, as shown in FIGS. 1B and 2C, with the minimum gas flow flowing from the intermediate chamber 9 to the outlet conduit 3. When the regulation valve 100 is in the minimum flow position Q_{MIN} the gas from the inlet conduit 2 fills the intermediate chamber 9 through the main valve opening 5 which is open, i.e. unblocked. The intermediate chamber 9 therefore allows a sufficient quantity of gas to accumulate to ensure the supply of the minimum flow rate Q_{MIN} to the outlet conduit 3 without interruptions nor fluctuations through the bypass opening 10 or 10'.

In an embodiment of the invention, the bypass opening 10 is arranged in the auxiliary plug 6b of the stem 6, as shown in the detail of FIG. 1C, the bypass opening 10 preferably comprising at least one cylindrical through hole passing through the auxiliary plug 6b from side to side, preferably being of constant section, generating a passage section. The diameter of this hole is sized to allow the passage of the minimum flow rate Q_{MIN} for a given type of gas, natural gas (NG) or liquefied gas (LPG). In a non-limiting example of the invention, not shown in the drawings, the bypass opening 10 comprises two through holes arranged in the auxiliary plug 6b distributed equidistantly, i.e. at 180°. In another non-limiting example of the invention, not shown in the drawings, the bypass opening 10 comprises three through holes arranged in the auxiliary plug 6b distributed equidistantly, i.e. at 120°. If the dimensions of the auxiliary plug 6b do not allow the manufacture of a single through hole, because there is no sufficient space or because it may weaken the auxiliary plug 6b, the fact of dividing the bypass opening 10 into more than one through hole makes it possible to manufacture said bypass opening 10 without damaging or weakening the stem 6.

In another embodiment of the invention, the bypass opening 10' comprises a first section 16a arranged in the main body 1, said first section 16a comprising an inlet opening 13 arranged at the intermediate chamber 9, as can be seen in the detail of FIG. 2B. The first section 16a is fluidically communicated to a second section 16b of the bypass opening 10' which is also arranged in the main body 1. Both sections 16a and 16b are arranged one next to the other, but in such a way as to form an angle, preferably an angle of 90°, as shown in FIG. 2D or in the detail of FIG. 2E. The second section 16b is fluidically connected to the outlet conduit 3. For a better understanding of the invention, in FIG. 2D, starting from the sectional view of FIG. 2C, the partial section A has been added to show the bypass opening 10', which in fact is hidden in another plane.

Arranging the bypass opening 10' in the main body 1 allows the bypass opening 10' to be operated from the outside of the valve assembly 200, which allows for example to easily adapt the bypass opening 10' for different types of gas, for example natural gas (NG) or liquefied petroleum gas (LPG).

In this sense, and in this embodiment, the control valve 100 comprises adjustment means associated with the bypass opening 10' allowing to vary a passage section 15 of the bypass opening 10', preferably arranged at the intersection between the first section 16a and the second section 6b, said passage section 15 defining the minimum flow rate Q_{MIN} of the control valve 100.

The adjustment means of this embodiment comprise an adjusting screw 14. An end of said adjusting screw 14, preferably the tip of the screw 14, is disposed at the intersection of the sections 16a and 16b of the bypass opening 10'. In the non-limiting example of FIG. 2D, the passage section 15 is comprised within the adjusting screw 14, preferably at the tip, and in fluidic communication with the first section 16a and the second section 16b of the bypass opening 10'. In this way, by replacing the adjusting screw 14 with another adjusting screw 14 comprising another passage section 15, the minimum flow rate Q_{MIN} can be easily varied in order to adjust it to different types of gas, e.g. natural gas (NG) or liquefied gas (LPG). In another example, not shown in the drawings, the end of the adjusting screw 14 is disposed partially at the intersection of the sections 16a and 16b of the bypass opening 10' such that it partially blocks the passage of gas through said intersection, the passage section 15 in this case being defined by the gap in said intersection not blocked by the adjusting screw 14, so that in this case by moving the adjusting screw 14 axially in one direction or the other the passage section 15 can be reduced or increased to allow the minimum flow rate Q_{MIN} to be varied to adjust it to different types of gas, e.g. natural gas (NG) or liquefied gas (LPG).

As shown in FIGS. 2D and 2E, the head of the adjusting screw 14 is accessible from the outside of the main body 1. Also, to prevent gas leakage, the adjusting screw 14 comprises a sealing gasket, preferably arranged near the tip of the screw 14.

In a non-limiting example of the invention, the main plug 6a and the auxiliary plug 6b form a single piece with the stem 6, said stem 6, as well as the main plug 6a and the auxiliary plug 6b, being preferably made of aluminium. The main body 1 of the valve assembly 200 is also made of aluminium, although the materials of the main body 1 and the stem 6 do not have to be the same or of the same alloy.

In the embodiment of the invention where the bypass opening 10' is arranged in the main body 1, the main valve seat 4 and the auxiliary valve seat 7 are rigid and form a single piece, both being preferably part of the main body 1, as shown in FIGS. 2A, 2B, 2C or 2D. Likewise, the main plug 6a and the auxiliary plug 6b of the stem 6 of this embodiment comprise a respective elastic ring 11a and 11b extending diametrically beyond the corresponding plug 6a and 6b. Said elastic rings 11a and 11b cooperate with the respective valve seat 4 or 7 to block the respective valve opening 5 or 8, as can be seen in FIGS. 2A and 2C. Thus, the main valve seat 4 and the auxiliary valve seat 7 being made of aluminium, the elastic rings 11a and 11b are made of an elastic material, preferably nitrile, thus ensuring a tight seal of the respective main valve opening 5 and the auxiliary valve opening 8 when the main plug 6a and the auxiliary plug 6b block the respective valve opening 5 or 8.

Also, in a non-limiting example of this embodiment, the diameter of the main valve opening 5 is larger than the diameter of the auxiliary valve opening 8, as shown in FIGS. 2A, 2B and 2C for example.

On the other hand, in the embodiment of the invention where the by-pass opening 10 is arranged in the auxiliary plug 6b, the main valve seat 4 and the auxiliary valve seat 7 also form a single piece and are integrated in a bushing 12 which is housed in the main body 1, as can be seen in the detail of FIG. 1C. The bushing 12, as well as the main valve seat 4 and auxiliary valve seat 7, are made of an elastic material, preferably of natural rubber or EPDM, so that the main plug 6a and the auxiliary plug 6b being metallic, preferably of aluminium, a tight seal of the respective main valve opening 5 and the auxiliary valve opening 8 is ensured when the main plug 6a and the auxiliary plug 6b block the respective valve opening 5 or 8.

Also, in a non-limiting example of this embodiment, the diameter of the main valve opening 5 is smaller than the diameter of the auxiliary valve opening 8, as shown in FIGS. 1A, 1B and 1C.

In an embodiment of the stem 6 of the embodiment of the invention where the by-pass opening 10 is arranged in the auxiliary plug 6b, the main plug 6a comprises a spheric shape main part having a radially extending annulus arm 6a’, said arm 6a’ cooperating with the main valve seat 4 to close or to open the control valve 100 of the invention, as described. In the same way, the auxiliary plug 6b comprises a flat flange, the bypass opening 10 being located in said flange, as shown for example in FIGS. 1A, 1B or 1C.

In another embodiment of the stem 6 of the by-pass opening 10’ is arranged in the main body 1, the main plug 6a also comprises a spheric shape main part having in the upper side a housing for housing the corresponding elastic ring 11a which extends diametrically beyond the spheric part. In this embodiment, the auxiliary plug 6b comprises an inverted triangular part having a housing for housing the corresponding elastic ring 11b, as shown for example in the detail of FIG. 2B.

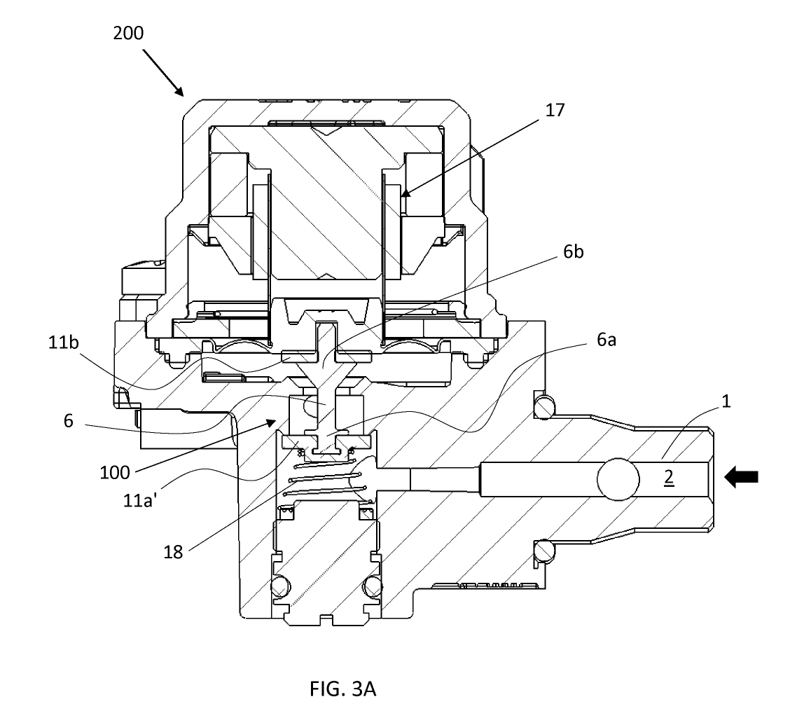

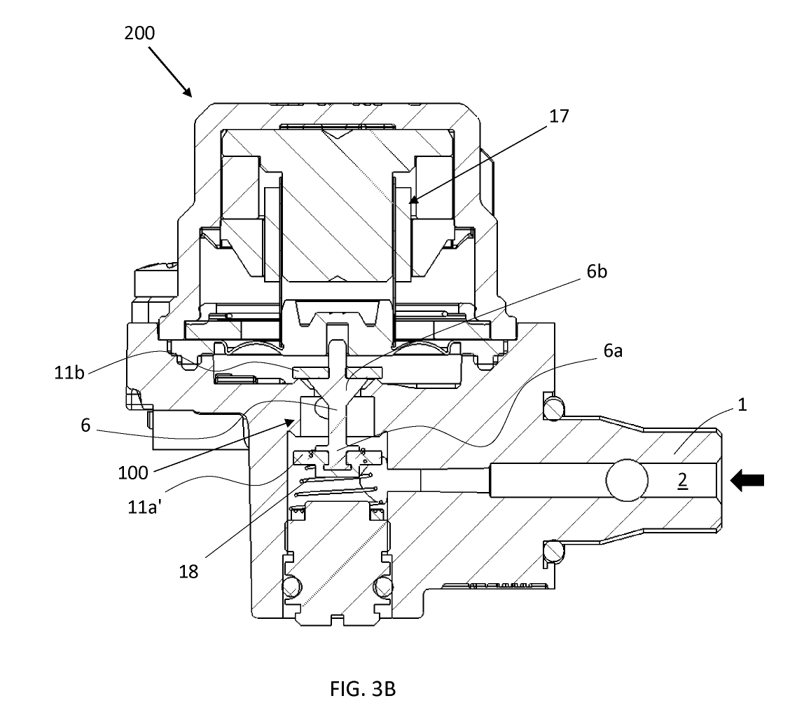

In a further embodiment of the stem 6 of the embodiment of the invention where the by-pass opening 10’ is arranged in the main body 1, the main plug 6a comprises a housing for housing an elastic body 11a’, preferably having an inverted hat shape, as shown in FIGS. 3A or 3B. In this embodiment, the auxiliary plug 6b also comprises an inverted triangular part having a housing for housing the corresponding elastic ring 11b.

As can be seen in the figures, the stem 6 is associated with actuating means of the valve assembly 200 which allow the stem 6 to move, preferably axially. According to a non-limiting example, the actuating means comprises an electromagnetic actuator 17 and elastic means, preferably a spring 18, as can be seen in the figures. In the non-limiting examples of the figures, the elastic means is associated with the stem 6, preferably with the main plug 6a, or with a part close to the main plug 6a, and the electromagnetic actuator 17 is also associated with the stem 6, preferably with a shaft 6' of said stem 6. In the closed position of the regulation valve 100 the electromagnetic actuator 17 is not activated and the elastic means tends to go to a rest position, i.e. to a non-compressed position, pushing the main plug 6a of the stem 6 against the main valve seat 4, as shown in FIGS. 1A and 2A, keeping the stem 6 in the rest position where the regulation valve 100 is kept closed. By activating the electromagnetic actuator 17 the stem 6 is displaced axially due to the electromagnetic forces generated, so that the main plug 6a is moved away from the main valve seat 4, opening the main valve opening 5, and thus the regulation valve 100. When the stem 6 is moved, the elastic means 18 is compressed by the stem 6, since the force exerted by the stem 6 against the spring 18 due to the electromagnetic forces is greater than the compressive force exerted by the spring 18 in the opposite direction. By controlling the magnitude of the electromagnetic forces generated by the electromagnetic actuator 17, the displacement of the stem 6, and thus the degree of opening of the regulation valve 100, can be controlled.

As already mentioned, when the main plug 6a blocks the opening of main valve 5, the regulation valve 100 is closed, and otherwise, i.e. when the main plug 6a does not block the main valve opening 5, the regulation valve 100 is open, being able to arranged the valve 100 in different opening positions that allow to direct more or less gas flow to the outlet conduit 3 depending on these positions. In the opening position corresponding to the position of Q_{MIN} the main plug 6a does not block the valve opening 5, but the auxiliary plug 6b blocks the auxiliary valve opening 8, the gas flow being directed to the outlet conduit 3 only through the corresponding by-pass opening 10 or 10'. In any other opening position of the regulation valve 100 neither of the valve openings 5 and 8 are blocked by the respective plugs 6a or 6b, the gas flow being directed in this case to the outlet conduit 3 through the auxiliary valve opening 8 and through the bypass opening 10 or 10', the quantity of gas passing through the bypass opening 10 or 10' being insignificant compared with the quantity of gas passing through the gap formed by the auxiliary valve opening 8 and the auxiliary plug 6b. The larger the gap, the greater the amount of gas passing into the outlet conduit 3 and vice versa.

The invention also relates to a gas burner, not shown in the figures, comprising the valve assembly 200 according to any of the described embodiments.

Embodiments are disclosed in the clauses that follow.

Clause 1. Valve assembly for a gas burner, comprising a main body (1), a gas inlet conduit (2), gas outlet conduit (3), and a regulation valve (100) arranged between the gas inlet conduit (2) and the gas outlet conduit (3), the regulation valve (100) comprising

a main valve seat (4) delimiting a main valve opening (5), and

an axially movable stem (6), comprising a main plug (6a) cooperating with the main valve seat (4), so that when the regulation valve (100) is in a closed position where no gas is allowed to pass from the inlet conduit (2) to the outlet conduit (3), the main plug (6a) rests on the main valve seat (4), blocking the main valve opening (5), the gas flow being able to be regulated by separating the main plug (6a) from the main valve seat (4),

the regulation valve (100) comprises an auxiliary valve seat (7) delimiting an auxiliary valve opening (8), the stem (6) comprising an auxiliary plug (6b) cooperating with the auxiliary valve seat (7), so that, when the regulation valve (100) is in a minimum flow position, the auxiliary plug (6b) rests on the auxiliary valve seat (7), blocking the auxiliary valve opening (8), allowing said minimum flow to pass to the outlet conduit (3) through at least one bypass opening (10; 10') arranged downstream of the main valve opening (5).

Clause 2. Valve assembly according to clause 1, wherein, starting from a neutral position of the stem (6) where the regulation valve (100) is closed, i.e. the main plug (6a) blocks the main valve opening (5), the displacement of the stem (6) in the minimum flow position is the maximum.

Clause 3. Valve assembly according to clause 2, wherein with the regulation valve (100) in the minimum flow position, an intermediate chamber (9) is created between the stem (6), the main valve seat (4) and the auxiliary valve seat (7), flowing the minimum gas flow from said intermediate chamber (9) to the outlet conduit (3).

Clause 4. Valve assembly according to clause 1 or 2, wherein the bypass opening (10') comprises a first section (16a) arranged in the main body (1) and comprising an inlet opening (13) arranged in the intermediate chamber (9), and a second section (16b) arranged in the main body (1) following the first section (16a) but forming an angle with respect to said first section (16a), preferably of 90º, said second section (16b) being fluidically communicated with the outlet conduit (3).

Clause 5. Valve assembly according to clause 4, wherein the regulation valve (100) comprises adjustment means associated with the bypass opening (10') allowing to vary a passage section (15) of said bypass opening (10'), preferably arranged at the intersection between the first section (16a) and the second section (16b), said passage section (15) defining the minimum flow rate of the regulation valve (100).

Clause 6. Valve assembly according to clause 5, wherein the adjusting means comprise an adjusting screw (14) which is associated with the passage section (15), an end of said adjusting screw (14) being arranged at the intersection of the two sections (16a, 16b), the passage section (15) being comprised within said screw (14) and in fluidic communication with the first section (16a) and the second section (6b) of the bypass opening (10'), or the end of the adjusting screw (14) being disposed partially at the intersection of the sections (16a, 16b) so as to partially block the gas passage through said intersection, the passage section (15) being defined by the gap at said intersection not blocked by the adjusting screw (14), so that by changing the adjusting screw (14), or by axially moving the adjusting screw (14) in one direction or the other, the passage section (15) can be reduced or increased to allow the minimum flow rate to be varied, said adjustment means being preferably configured so that the adjusting screw (14) can be actuated from the outside of the main body (1).

Clause 7. Valve assembly according to any of clauses 1 to 3, wherein the bypass opening (10) is arranged at the auxiliary plug (6b) of the stem (6), the bypass opening (10) preferably comprising at least one cylindrical through bore that passes through the auxiliary plug (6b) from side to side.

Clause 8. Valve assembly according to any of the preceding clauses, wherein the main plug (6a) and the auxiliary plug (6b) form a single part with the stem (6).

Clause 9. Valve assembly according to any of the preceding clauses, wherein the main valve seat (4) and the auxiliary valve seat (7) are rigid and form a single part, preferably forming part of the main body (1).

Clause 10. Valve assembly according to clause 9, wherein the main plug (6a) and the auxiliary plug (6b) of the stem (6) comprise a respective elastic ring (11a, 11b) extending diametrically beyond the respective plug (6a, 6b), said elastic rings (11a, 11b) cooperating with the respective valve seat (4, 7) to block the respective valve opening (5, 8).

Clause 11. Valve assembly according to clause 10, wherein the elastic rings (11a, 11b) are made of an elastic material, preferably nitrile, and the main valve seat (4) and the auxiliary valve seat (7) are metallic, preferably aluminium.

Clause 12. Valve assembly according to any of clauses 1 to 8, wherein the main valve seat (4) and the auxiliary valve seat (7) are elastic and are integrated in a bushing (12) being housed in the main body (1).

Clause 13. Valve assembly according to clause 12, wherein the bushing (12) is made of natural rubber or EPDM, and the main plug (6a) and the auxiliary plug (6b) are metallic, preferably aluminium.

Clause 14. Valve assembly according to any of the preceding clauses, wherein the stem (6) is associated with actuating means of the valve assembly (200) that allow to move said stem (6), the actuating means comprising an electromagnetic actuator (17) and elastic means, preferably a spring (18), so that in the closed position of the regulation valve (100) the electromagnetic actuator (17) is not activated and the elastic means tends to go to a rest position, pushing the main plug (6a) of the stem (6) against the main valve seat (4), and so that when the electromagnetic actuator (17) is actuated, the stem (6) is displaced moving the main plug (6a) away from the main valve seat (4), compressing the elastic means (18) and opening the regulation valve (100).

Clause 15. Gas burner comprising a valve assembly according to any of the preceding clauses.

1. A valve assembly for a gas burner, the valve assembly comprising:
a main body;
a gas inlet conduit;,
a gas outlet conduit;, and
a regulation valve arranged between the gas inlet conduit and the gas outlet conduit, the regulation valve including:
a main valve seat delimiting a main valve opening,
an auxiliary valve seat delimiting an auxiliary valve opening;
a stem that is axially movable between a first axial position and a second axial position, the stem including a main plug and an auxiliary plug;
in the first axial position of the stem the main plug cooperates with the main valve seat to block the main valve opening so that the regulation valve is in a closed position to prevent gas to pass from the gas inlet conduit to the gas outlet conduit, in the second axial position of the stem the main plug does not cooperate with the main seat to permit gas to pass from the gas inlet conduit to the gas outlet conduit;
in the first axial position of the stem the auxiliary plug does not cooperate with the auxiliary valve seat, in the second axial position of the stem the auxiliary plug cooperates with the auxiliary valve seat to block the auxiliary valve opening; and
a bypass conduit through which gas passes when the stem is in the second axial position, the bypass conduit being located downstream the main valve opening and being sized to establish a minimum flow of gas between the gas inlet conduit and the gas outlet conduit.

2. The valve assembly according to claim 1, wherein when the stem is in the second axial position a separation distance between the main plug and the main valve seat is at a maximum.

3. The valve assembly according to claim 2, wherein when the valve stem in the second axial position, an intermediate chamber is created between the stem, the main valve seat and the auxiliary valve seat, the intermediate chamber being in fluid communication with the gas outlet conduit.

4. The valve assembly according to claim 1, wherein the bypass conduit comprises a first section arranged in the main body, an inlet opening arranged in the intermediate chamber, and a second section arranged in the main body following the first section, the second section forming an angle with respect to the first section, the second section being in fluid communication with the gas outlet conduit.

5. The valve assembly according to claim 4, wherein the regulation valve comprises adjustment means associated with the bypass conduit allowing to vary a passage section of the bypass conduit, the passage section defining the minimum flow of gas.

6. The valve assembly according to claim 5, wherein the adjustment means is arranged at the intersection between the first section and the second section.

7. The valve assembly according to claim 5, wherein the passage section comprises an adjusting screw which is associated with the passage section, an end of the adjusting screw being arranged at the intersection of the first and second sections, the passage section being comprised within the adjusting screw and in fluid communication with the first section and the second section of the bypass conduit.

8. The valve assembly according to claim 5, wherein the adjusting means comprises an adjusting screw which is associated with the passage section, an end of the adjusting screw being disposed partially at the intersection of the first and second sections so as to partially block the gas passage through the intersection, the passage section being defined by the gap at the intersection not blocked by the adjusting screw, so that by changing the adjusting screw, or by axially moving the adjusting screw in one direction or the other, the passage section can be reduced or increased to allow the minimum flow rate to be varied.

9. The valve assembly according to claim 7, wherein the adjusting screw is actuated from outside the main body.

10. The valve assembly according to claim 8, wherein the adjusting screw is actuated from outside the main body.

11. The valve assembly according to claim 1, wherein the bypass conduit is arranged in the auxiliary plug.

12. The valve assembly according to claim 11, wherein the bypass conduit includes at least one cylindrical through bore that passes through the auxiliary plug.

13. The valve assembly according to claim 1, wherein the main plug and the auxiliary plug form a single part with the stem.

14. The valve assembly according to claim 1, wherein the main valve seat and the auxiliary valve seat are rigid and form a single part.

15. The valve assembly according to claim 14, wherein the main valve seat and the auxiliary valve seat form part of the main body.

16. The valve assembly according to claim 13, wherein the main valve seat and the auxiliary valve seat are rigid and form a single part.

17. The valve assembly according to claim 14, further comprising first and second elastic rings respectively attached to the main plug and the auxiliary plug and configured to respectively cooperate with the main valve seat and the auxiliary valve seat.

18. The valve assembly according to claim 17, wherein the first and second elastic rings are made of an elastic material, and the main valve seat and the auxiliary valve seat are metallic.

19. The valve assembly according to claim 1, wherein the main valve seat and the auxiliary valve seat are elastic and are integrated in a bushing housed in the main body.

20. A valve assembly according to claim 1, wherein the stem is associated with actuating means of the valve assembly that allow to move the stem between the first and second axial positions, the actuating means comprising an electromagnetic actuator and elastic means, so that in the closed position of the regulation valve the electromagnetic actuator is not activated and the elastic means continuously pushes the main plug towards the main valve seat, when the electromagnetic actuator is actuated, the stem is displaced moving the main plug away from the main valve seat, compressing the elastic means and opening the regulation valve.
